(19) United States
(12) Patent Application Publication
(10) Pub. No.: US 2016/0096481 A1
(43) Pub. Date: Apr. 7, 2016

(54) Expandable Vehicle Rack Device

(71) Applicant: Zeljko Sabo, Garland, TX (US)

(72) Inventor: Zeljko Sabo, Garland, TX (US)

(21) Appl. No.: 14/507,961

(22) Filed: Oct. 7, 2014

(51) Int. Cl. B60R 9/06

(52) U.S. Cl. CPC B60R 9/06

(57) ABSTRACT

An expandable vehicle rack device expands to allow secure attachment to variously sized vehicles. The device includes each of a plurality of brackets having a base flange extending from a connection flange. Each bracket is structured to provide a pair of angled slots in the connection flange. Each of a plurality of fasteners is insertable through an associated one of the angled slots for securing the brackets to a vehicle. Each of a plurality of uprights is coupled to an associated one of the brackets in a static position relative to the associated bracket. An upper frame has a plurality of corner sections. Each of the corner sections is couplable to an associated one of the uprights. Each side of the upper frame and each end of the upper frame is expandable wherein each corner section is selectively positionable to align with the upper ends of the associated upright.

### BACKGROUND OF THE DISCLOSURE

### Field of the Disclosure

The disclosure relates to vehicle rack devices and more particularly pertains to a new vehicle rack device for which expands to allow the device to be attached securely to variously sized vehicles.

### SUMMARY OF THE DISCLOSURE

An embodiment of the disclosure meets the needs presented above by generally comprising each of a plurality of brackets having a base flange extending from a connection flange. Each bracket is structured to provide a pair of angled slots in the connection flange. Each of a plurality of fasteners is insertable through an associated one of the angled slots for securing the brackets to a vehicle. Each of a plurality of uprights is coupled to an associated one of the brackets in a static position relative to the associated bracket. An upper frame has a plurality of corner sections. Each of the corner sections is couplable to an associated one of the uprights. Each side of the upper frame and each end of the upper frame is expandable wherein each corner section is selectively positionable to align with the upper ends of the associated upright.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a expandable vehicle rack device according to an embodiment of the disclosure.

FIG. 2 is a top front side perspective view of a bracket of an embodiment of the disclosure.

FIG. 3 is a front view of a bracket of an embodiment of the disclosure.

FIG. 4 is a partial back view of an embodiment of the disclosure.

FIG. 5 is a partially exploded top back view detailed view of an embodiment of the disclosure.

FIG. 6 is a cross-sectional view of an embodiment of the disclosure taken along line 6-6 of FIG. 1.

### DESCRIPTION OF THE PREFERRED EMBODIMENT

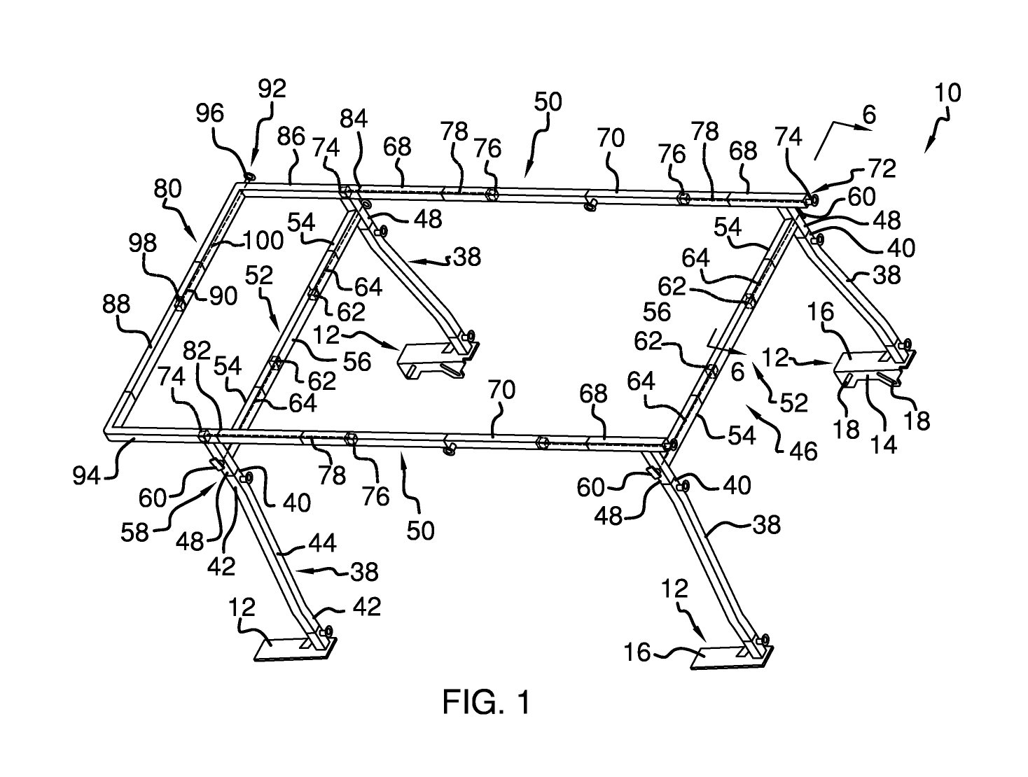

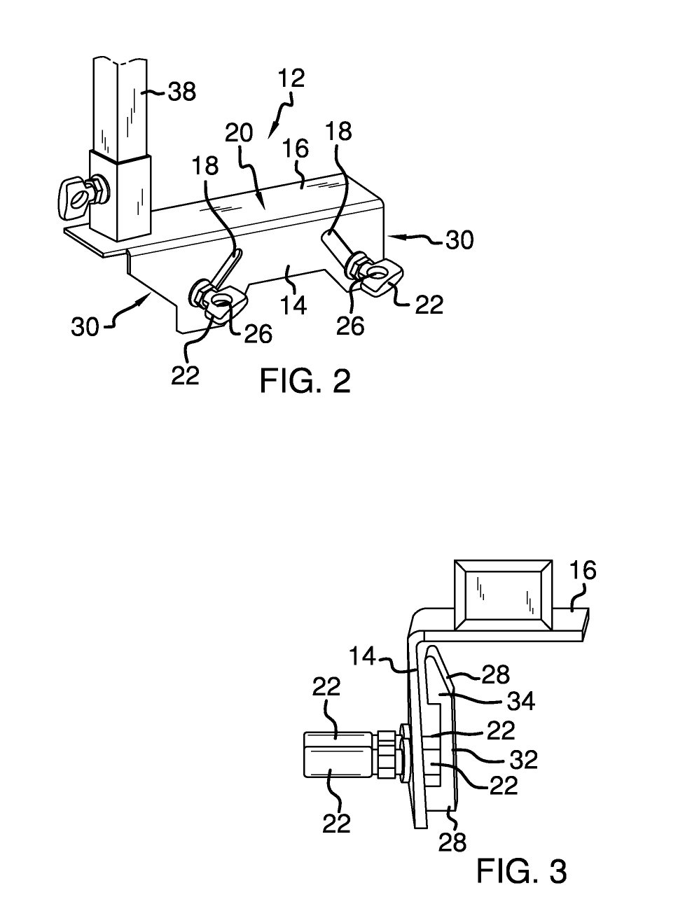

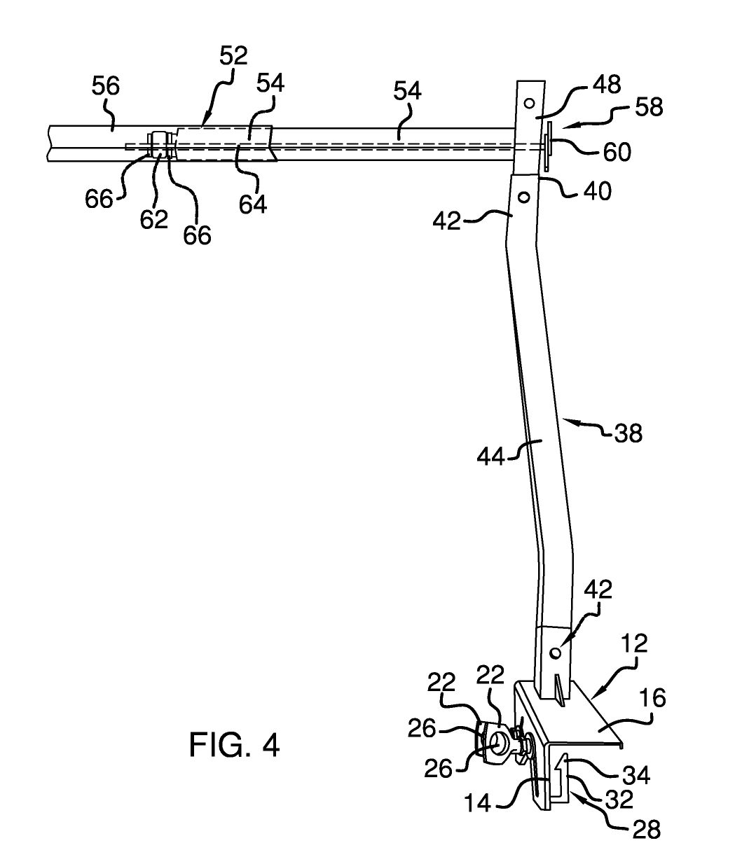

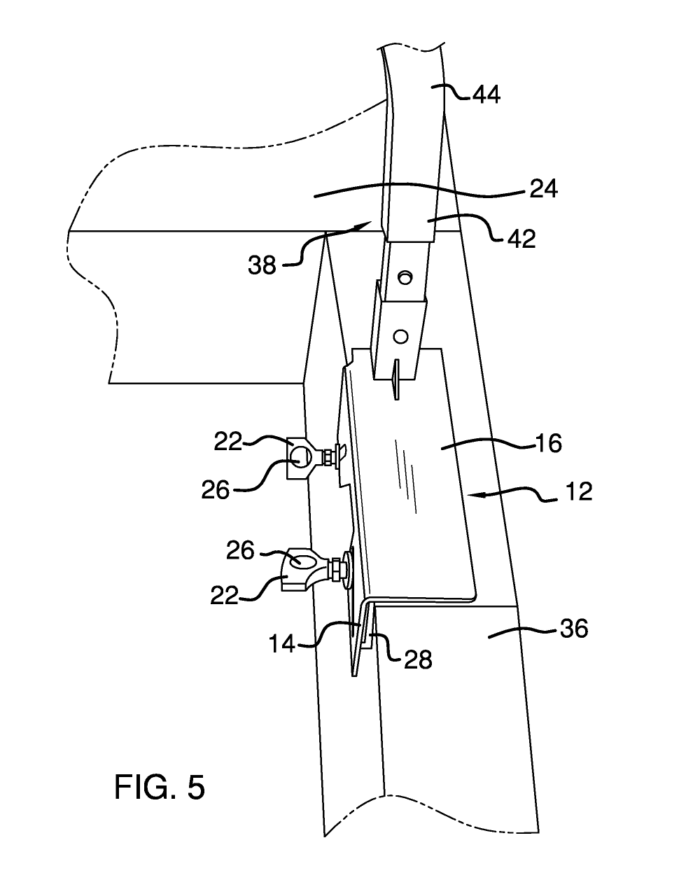

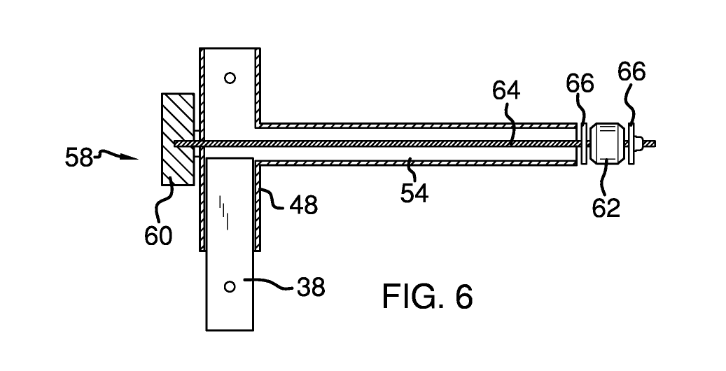

With reference now to the drawings, and in particular to FIGS. 1 through 6 thereof, a new vehicle rack device embodying the principles and concepts of an embodiment of the disclosure and generally designated by the reference numeral 10 will be described.

As best illustrated in FIGS. 1 through 6, the expandable vehicle rack device 10 generally comprises a plurality of brackets 12. Each of the brackets 12 has a connection flange 14 and a base flange 16. The connection flange 14 extends perpendicularly from the base flange 16. Each bracket 12 is structured to provide a pair of angled slots 18 in the connection flange 14. The angled slots 18 extend outwardly relative to a middle 20 of the connection flange 14 as the angled slots 18 extend away from the base flange 16. Each of a plurality of fasteners 22 is insertable through an associated one of the angled slots 18 wherein the fasteners 22 are configured for securing the brackets 12 to a vehicle 24 by engaging the fasteners 22 to the vehicle 24. Each of the fasteners 22 is structured to include a respective hole 26 extending through the fastener 22 wherein each fastener 22 is configured to be engageable by a rod such as a screwdriver, or the like, to facilitate rotation of the fastener 22. Each of a plurality of clips 28 is coupled to an associated bracket 12. Two clips 28 may be coupled to each bracket 12. Each clip 28 is positioned near an associated end 30 of the associated bracket 12. Each clip 28 extends from the connection flange 14 of the associated bracket 12 such that the clip 28 is positioned under the base flange 16. Each of the clips 28 has a shaft 32 and a barbed end 34. Each fastener 22 is urged towards the clips 28 such that the fasteners 22 are configured for clamping a sidewall 36 of the vehicle 24 between the associated connection flange 14 and the associated clips 28. The fasteners 28 are positionable in the angled slots 18 to adjust to best fit the sidewall 36 of different vehicle brands.

Each of a plurality of uprights 38 is coupled to an associated one of the brackets 12 such that an upper end 40 of the upright 38 is positioned in a static position relative to the associated bracket 12. Each upright 38 may be coupled to a socket or collar fixed on the base flange 16 of the bracket 12. The upright 38 may be secured using a biased pin and aligned aperture mechanism or other conventional connection to securely attach the upright 38 to the bracket 12. Each upright has a pair of parallel sections 42 offset by a middle extent 44. Each upright 38 is positionable relative to the bracket 12 to position the upper end 40 of each upright 38 to be offset inwardly or outwardly relative to the bracket 12. If desired, the uprights 38 may further be designed to be couplable to the brackets 12 such that the upper ends 40 may be selectively offset forwardly or rearwardly relative to the brackets 12 as desired to provide customized positioning of the upper ends 40.

An upper frame 46 has a plurality of corner sections 48, a pair of sides 50 coupled to and extending between respective pairs of the corner sections 48, and a pair of ends 52 coupled to and extending between respective pairs of the corner sections 48. Each of the corner sections 48 is couplable to an associated one of the uprights 38. Each of the sides 50 of the upper frame 46 and the ends 52 of the upper frame 46 is expandable wherein each corner section 48 is selectively positionable to align with the upper end 40 of the associated upright 38. The uprights 38 and components of the upper frame 46 may be square tubing.

Each end 52 of the upper frame 46 comprises a pair of fixed end sections 54. Each of the fixed end sections 54 is coupled to an associated one of the corner sections 48. Each end 52 of the upper frame 46 further comprises a medial end section 56 slidably receiving each of the fixed end sections 54. Each of a plurality of end locks 58 couples an associated medial end section 56 to a respective one of the fixed end sections 54. Thus, a length of each end 52 of the upper frame 46 is static when the end lock 58 is engaged. Each end lock 58 comprises an end handle 60 extending from the respective one of the corner sections 48, an end expansion member 62, and an end expansion shaft 64. The end expansion shaft 64 is coupled to and extends between the end handle 60 and the end expansion member 62 such that the end expansion member 62 is extended from the associated fixed end section 54. The end handle 60 is manipulatable to rotate the end expansion shaft 64. The end expansion member 62 is expanded by rotation of the end expansion shaft 64. This is achieved by conventional threaded coupling of the end expansion shaft 64 to washers 66 which compress the end expansion member 62 when the end handle 60 is rotated in a tightening direction. Each washer 66 may have a shape complementary to an interior shape of the square tubing. The end expansion member 62 is positionable within the medial end section 56 such that expansion of the end expansion member 62 securely engages the end expansion member 62 to the medial end section 56 wherein the associated fixed end section 54 is held in a fixed position relative to the medial end section 56.

Similarly, each side 50 of the upper frame 46 comprises a pair of fixed side sections 68. Each of the fixed side sections 68 is coupled to an associated one of the corner sections 48. Each side 50 of the upper frame 46 comprises a medial side section 70. The medial side section 70 slidably receives each of the fixed side sections 68. Each of a plurality of side locks 72 selectively couples an associated medial side section 70 to a respective one of the fixed side sections 68 wherein a length of each side 50 of the upper frame 46 is static when the side locks 72 are engaged. Each side lock 72 comprises a side handle 74 extending from the respective one of the corner sections 48, a side expansion member 76, and a side expansion shaft 78 coupled to and extending between the side handle 74 and the side expansion member 76 such that the side expansion member 76 is extended from the associated fixed side section 68. The side handle 74 is manipulatable to rotate the side expansion shaft 78 wherein the side expansion member 76 is expanded in similar fashion to the expansion of each end expansion member 62. The side expansion member 76 is positionable within the medial side section 70 such that expansion of the side expansion member 76 securely engages the side expansion member 76 to the medial side section 70 wherein the associated fixed side section 68 is held in a fixed position relative to the medial side section 70. The sides 50 of the upper frame 46 may be coplanar and the ends 52 of the upper frame 46 may also be coplanar and vertically offset from and parallel to the ends 52 of the upper frame 46.

An extension frame 80 may be provided having a first end 82 and a second end 84. The first end 82 of the extension frame 80 and the second end 84 of the extension frame 80 are each coupled to the upper frame 46. Each of the first end 82 of the extension frame 80 and the second end 84 of the extension frame 80 is couplable to a respective one of the sides 50 of the upper frame 46. Each of the first end 82 and the second end 84 may extend over a respective one of the side handles 74 when coupled to the respective sides 50. The extension frame 80 has a pair of elbows 86,94 and a crossbar 88. One of the elbows 86 has an end section 90 slidably inserted into the crossbar 88 wherein a distance between the elbows 86,94 is adjustable. An extension lock 92 selectively couples the one of the elbows 86 to the crossbar 88 wherein the distance between the elbows 86,94 is static when the extension lock 92 is engaged. The extension lock 92 comprises an extension handle 96 extending from the one of the elbows 86, an extension expansion member 98, and an extension expansion shaft 100 coupled to and extending between the extension handle 96 and the extension expansion member 98 such that the extension expansion member 98 is extended from the end section 90 of the elbow 86. The extension handle 96 is manipulatable to rotate the extension expansion shaft 100 such that the extension expansion member 98 is expanded by rotation of the extension expansion shaft 100. The extension expansion member 98 is positionable within the crossbar 88 such that expansion of the extension expansion member 98 securely engages the extension expansion member 98 to the crossbar 88 wherein the one of the elbows 86 is held in a fixed position relative to the crossbar 88.

In use, the brackets 12 are coupled to the vehicle 24. The uprights 38 are coupled to the brackets 12 and the upper frame 46 is expanded to align the corner sections 48 with the upper ends 40 of the uprights 38. The upper frame 46 is secured using the end locks 58 and side locks 72 to prevent unintended expansion or contraction of the upper frame 46. When desired, the extension frame 80 is adjusted for size and coupled to the upper frame 46. The device 10 may then be used in the manner of a conventional vehicle rack. The device 10 may be detached and reattached as desired. Further, the device 10 may be attached to differently sized vehicles using only adjustment of the relative positioning of components of the device 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An expandable vehicle rack device comprising:
a plurality of brackets, each of said brackets having a connection flange and a base flange, said connection flange extending from said base flange, each said bracket being structured to provide a pair of angled slots in said connection flange;
a plurality of fasteners, each of said fasteners being insertable through an associated one of said angled slots wherein said fasteners are configured for securing said brackets to a vehicle by engaging said fasteners to the vehicle;
a plurality of uprights, each said upright being coupled to an associated one of said brackets such that an upper end of said upright is positioned in a static position relative to said associated bracket; and
an upper frame, said upper frame having a plurality of corner sections, a pair of sides coupled to and extending between respective pairs of said corner sections, and a pair of ends coupled to and extending between respective pairs of said corner sections, each of said corner sections being couplable to an associated one of said uprights, each of said sides of said upper frame and said ends of said upper frame being expandable wherein each said corner section is selectively positionable to align with said upper ends of said associated upright.

2. The device of claim 1, further comprising:
each said end of said upper frame comprising a pair of fixed end sections, each of said fixed end sections being coupled to an associated one of said corner sections; and
each said end of said upper frame comprising a medial end section, said medial end section slidably receiving each of said fixed end sections.

3. The device of claim 2, further comprising a plurality of end locks, each said end lock selectively coupling an associated said medial end section to a respective one of said fixed end sections wherein a length of each said end of said upper frame is static when said end lock is engaged.

4. The device of claim 3, further comprising each said end lock comprising an end handle extending from said respective one of said corner sections, an end expansion member extending through an associated said fixed end section, and an end expansion shaft coupled to and extending between said end handle and said end expansion member such that said end expansion member is extended from said associated fixed end section, said end handle being manipulatable to rotate said end expansion shaft, said end expansion member being expanded by rotation of said end expansion shaft, said end expansion member being positionable within said medial end section such that expansion of said end expansion member securely engages said end expansion member to said medial end section wherein said associated fixed end section is held in a fixed position relative to said medial end section.

5. The device of claim 1, further comprising said angled slots extending outwardly relative to a middle of said connection flange as said angle slots extend away from said base flange.

6. The device of claim 1, further comprising each of said fasteners being structured to include a respective hole extending through said fastener wherein each said fastener is configured to be engageable by a rod to facilitate rotation of said fastener.

7. The device of claim 1, further comprising a plurality of clips, each said clip being coupled to an associated said bracket, each said clip extending from said connection flange of said bracket such that said clip is positioned under said base flange.

8. The device of claim 7, further comprising each of said clips having a shaft and a barbed end.

9. The device of claim 8, further comprising each said fastener being urged towards said clips such that said fasteners are configured for clamping a sidewall of a vehicle between said associated connection flange and said associated clips.

10. The device of claim 1, further comprising:
each said side of said upper frame comprising a pair of fixed side sections, each of said fixed side sections being coupled to an associated one of said corner sections; and
each said side of said upper frame comprising a medial side section, said medial side section slidably receiving each of said fixed side sections.

11. The device of claim 10, further comprising a plurality of side locks, each said side lock selectively coupling an associated said medial side section to a respective one of said fixed side sections wherein a length of each said side of said upper frame is static when said side locks are engaged.

12. The device of claim 11, further comprising each said side lock comprising a side handle extending from said respective one of said corner sections, a side expansion member extending through an associated said fixed side section, and a side expansion shaft coupled to and extending between said side handle and said side expansion member such that said side expansion member is extended from said associated fixed side section, said side handle being manipulatable to rotate said side expansion shaft, said side expansion member being expanded by rotation of said side expansion shaft, said side expansion member being positionable within said medial side section such that expansion of said side expansion member securely engages said side expansion member to said medial side section wherein said associated fixed side section is held in a fixed position relative to said medial side section.

13. The device of claim 1, further comprising an extension frame having a first end and a second end, said first end of said extension frame and said second end of said extension frame being coupled to said upper frame.

14. The device of claim 13, further comprising each of said first end of said extension frame and said second end of said extension frame being couplable to a respective one of said sides of said upper frame.

15. The device of claim 13, further comprising said extension frame having a pair of elbows and a crossbar, one of said elbows having an end section slidably inserted into said crossbar wherein a distance between said elbows is adjustable.

16. The device of claim 15, further comprising an extension lock, said extension lock selectively coupling said one of said elbows to said crossbar wherein the distance between said elbows is static when said extension lock is engaged.

17. The device of claim 16, further comprising said extension lock comprising an extension handle extending from said one of said elbows, an extension expansion member, and an extension expansion shaft coupled to and extending between said extension handle and said extension expansion member such that said extension expansion member is extended from said end section of said elbow, said extension handle being manipulatable to rotate said extension expansion shaft, said extension expansion member being expanded by rotation of said extension expansion shaft, said extension expansion member being positionable within said crossbar such that expansion of said extension expansion member securely engages said extension expansion member to said crossbar wherein said one of said elbows is held in a fixed position relative to said crossbar.

18. An expandable vehicle rack device comprising:
a plurality of brackets, each of said brackets having a connection flange and a base flange, said connection flange extending from said base flange, each said bracket being structured to provide a pair of angled slots in said connection flange, said angled slots extending outwardly relative to a middle of said connection flange as said angle slots extend away from said base flange;
a plurality of fasteners, each of said fasteners being insertable through an associated one of said angled slots wherein said fasteners are configured for securing said brackets to a vehicle by engaging said fasteners to the vehicle, each of said fasteners being structured to include a respective hole extending through said fastener wherein each said fastener is configured to be engageable by a rod to facilitate rotation of said fastener;
a plurality of clips, each said clip being coupled to an associated said bracket, each said clip extending from said connection flange of said bracket such that said clip is positioned under said base flange, each of said clips having a shaft and a barbed end, each said fastener being urged towards said clips such that said fasteners are configured for clamping a sidewall of a vehicle between said associated connection flange and said associated clips;
a plurality of uprights, each said upright being coupled to an associated one of said brackets such that an upper end of said upright is positioned in a static position relative to said associated bracket;
an upper frame, said upper frame having a plurality of corner sections, a pair of sides coupled to and extending between respective pairs of said corner sections, and a pair of ends coupled to and extending between respective pairs of said corner sections, each of said corner sections being couplable to an associated one of said uprights, each of said sides of said upper frame and said ends of said upper frame being expandable wherein each said corner section is selectively positionable to align with said upper ends of said associated upright;
each said end of said upper frame comprising a pair of fixed end sections, each of said fixed end sections being coupled to an associated one of said corner sections, each said end of said upper frame comprising a medial end section, said medial end section slidably receiving each of said fixed end sections;
a plurality of end locks, each said end lock selectively coupling an associated said medial end section to a respective one of said fixed end sections wherein a length of each said end of said upper frame is static when said end lock is engaged, each said end lock comprising
an end handle extending from said respective one of said corner sections,
an end expansion member, and
an end expansion shaft coupled to and extending between said end handle and said end expansion member such that said end expansion member is extended from said associated fixed end section, said end handle being manipulatable to rotate said end expansion shaft, said end expansion member being expanded by rotation of said end expansion shaft, said end expansion member being positionable within said medial end section such that expansion of said end expansion member securely engages said end expansion member to said medial end section wherein said associated fixed end section is held in a fixed position relative to said medial end section;
each said side of said upper frame comprising a pair of fixed side sections, each of said fixed side sections being coupled to an associated one of said corner sections, each said side of said upper frame comprising a medial side section, said medial side section slidably receiving each of said fixed side sections;
a plurality of side locks, each said side lock selectively coupling an associated said medial side section to a respective one of said fixed side sections wherein a length of each said side of said upper frame is static when said side locks are engaged, each said side lock comprising
a side handle extending from said respective one of said corner sections,
a side expansion member, and
a side expansion shaft coupled to and extending between said side handle and said side expansion member such that said side expansion member is extended from said associated fixed side section, said side handle being manipulatable to rotate said side expansion shaft, said side expansion member being expanded by rotation of said side expansion shaft, said side expansion member being positionable within said medial side section such that expansion of said side expansion member securely engages said side expansion member to said medial side section wherein said associated fixed side section is held in a fixed position relative to said medial side section;
an extension frame having a first end and a second end, said first end of said extension frame and said second end of said extension frame being coupled to said upper frame, each of said first end of said extension frame and said second end of said extension frame being couplable to a respective one of said sides of said upper frame, said extension frame having a pair of elbows and a crossbar, one of said elbows having an end section slidably inserted into said crossbar wherein a distance between said elbows is adjustable; and
an extension lock, said extension lock selectively coupling said one of said elbows to said crossbar wherein the distance between said elbows is static when said extension lock is engaged, said extension lock comprising an extension handle extending from said one of said elbows, an extension expansion member, and an extension expansion shaft coupled to and extending between said extension handle and said extension expansion member such that said extension expansion member is extended from said end section of said elbow, said extension handle being manipulatable to rotate said extension expansion shaft, said extension expansion member being expanded by rotation of said extension expansion shaft, said extension expansion member being positionable within said crossbar such that expansion of said extension expansion member securely engages said extension expansion member to said crossbar wherein said one of said elbows is held in a fixed position relative to said crossbar.
